(19) United States
(12) Patent Application Publication
(10) Pub. No.: US 2026/0356150 A1
(43) Pub. Date: Nov. 12, 2026

(54) Hybrid Coil Spring Isolator

(71) Applicant: BASF SE, Ludwigshafen am Rhein (DE)

(72) Inventor: Sadiq Al-Dahhan, Dearborn, MI (US)

(73) Assignee: BASF SE, Ludwigshafen am Rhein (DE)

(21) Appl. No.: 19/130,596

(22) PCT Filed: Dec. 15, 2023
(86) PCT No.: PCT/US2023/084340

§ 371 Date: May 16, 2025

Related U.S. Application Data
(60) Provisional application No. 63/433,783, filed on Dec. 20, 2022.

(30) Foreign Application Priority Data
Mar. 29, 2023 (EP) 23165002.9

(51) Int. Cl. B60G 15/06

(52) U.S. Cl. CPC B60G 15/063; B60G 2202/312; B60G 2204/1242; B60G 2206/73

(57) ABSTRACT

An isolator (101) in a suspension system, the isolator (101) comprising: a. at least one microcellular polyurethane (MCU); b. a composite region (103) encapsulating the at least one MCU, wherein the composite region (103) encapsulates the at least one MCU partially or completely.

### FIELD OF INVENTION

The present invention relates to an isolator, a method of forming the isolator, a suspension system as well as a vehicle comprising the same.

### BACKGROUND OF THE INVENTION

A suspension system of a vehicle engages to limit vibrations as well as absorb impact force from being transmitted to a frame member of the vehicle. Components of the suspension system include a spring, spring isolators and shock/strut. Coil springs are commonly used in the suspension systems to absorbs energy generated by the impact force. Capacity of the coil springs are configured as per the required load bearing capacity of the vehicle.

The coil spring isolators are provided to absorb vibrations, isolate rolling noise, and provide even loading of the spring. The coil spring isolators by absorbing vibrations, reduce damage to arms of the coil spring. Working of the suspension system is also improved as the coil spring isolate the car against vibrations and jostling. Soft coil spring isolators fail to absorb the excess impact force and jostles. However, as stiffness of coil spring isolators is excessively increased, the coil spring isolators start transferring the vibrations and impact force to the vehicle body. Accordingly, stiffness of the coil spring isolators has to be maintained. Structural integrity of the coil spring isolators deteriorates over time based on material used, duration of actual usage and exposure to environment. Accordingly, there exists need to improve the coil spring isolator in the suspension system.

It was, therefore, an object of the present invention to provide for an improved suspension system to absorb vibrations, absorb jostles, manage variable axial loads without damage, reduce friction in components with least modification of the suspension system and the vehicle, and in a cost-effective manner.

### SUMMARY OF THE INVENTION

Surprisingly, it has been found that the above identified object is met by providing an isolator for a suspension system, a method of forming the isolator, a suspension system as well as a vehicle comprising the same.

The isolator is disposed at end of arms of a spring in the suspension system for a vehicle. The isolator articulates with the arms of the spring as well as a movable component and a vehicle body. The isolator absorbs vibrations, jostling, surplus energy transmitted by impact between the movable component and the spring. The isolator avoids transmission of vibrations, impact force to the vehicle body/frame of the vehicle as well as reduce failure of the suspension system components. The isolator also provides for a cost-effective solution to improve the suspension without implementing any other structure modifications to the vehicle.

Accordingly, in one aspect, the presently claimed invention is directed to an isolator (101) in a suspension system (201), the isolator (101) comprising:
a. at least one microcellular polyurethane (MCU) (102);
b. a composite region (103) encapsulating the at least one MCU (102),
wherein the composite region (103) encapsulates the at least one MCU (102) partially or completely, and
c. optionally, at least one support region (105) attached to an at least one surface (104) of the composite region (103).

In another aspect, the presently claimed invention is directed to a method of forming the isolator (101) of claim 1, wherein the method comprising:
a. providing at least one MCU (102) in a mold for the isolator (101);
b. optionally, providing the at least one support region (105) in the mold for the isolator (101)
c. injecting a mixture to form the composite region (103) into the mold and over the at least one MCU and the at least one support region (105);
d. optionally curing the mixture to form the isolator (101);
e. releasing the isolator (101) from the mold.

In another aspect, the presently claimed invention is directed to a suspension system (200) for a vehicle (300) having a vehicle body (301) and a movable component (302) displaceable relative to the vehicle body (301), the suspension system (200) comprising:
a. a spring (400) including a first arm (401) that articulates with a spring seat region (311) of the vehicle body (301) and a second arm (402) that articulates with a spring seat region (312) of the movable component (302); and
b. the at least one isolator (101) as claimed in any one of claims 1 to 12,
wherein the at least one isolator is disposed between
   the first arm (401) of a spring (400) and a spring seat region (311) of a vehicle body (301) of a vehicle, or
   the second arm (402) and a spring seat region (312) of a movable component (302) of the vehicle,
   or both.

In another aspect, the presently claimed invention is directed to a vehicle (300) comprising:
a. the vehicle body (301);
b. the movable component (302) displaceable relative to the vehicle body (301); and
c. the suspension system (200) with the at least one isolator (101) as claimed in claim 16.

### BRIEF DESCRIPTION OF THE FIGURES

FIG. 1 shows the isolator (101). FIGS. 1a and 1b provide perspective view and cross-sectional view respectively. FIG. 1c provides cross sectional view of the isolator (101E) with two MCU in shape of discs, stacked co-axially.

FIG. 2 is cross-sectional view of the isolator (101a), (101b) and (101c) respectively.

FIG. 3 is a view of a suspension system (200) having a spring (400) and the isolators (101). FIG. 3a provides view of the suspension system (200) with the spring (400), the arms (401) and the isolators (101) are not in straight line of travel. FIG. 3b provide view of the suspension system (200) the spring (400) and the isolators (101) in straight line of travel.

FIG. 4 is a view of the suspension system (200) in form of a MacPherson strut assembly.

FIG. 5 is a perspective view of the suspension system (200) of a vehicle (300) having the isolators (101).

### DETAILED DESCRIPTION OF THE INVENTION

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e., a range of 1 to 10 implies that both 1 and 10 are included in the range. For the avoidance of doubt, the applicant shall be entitled to any equivalents according to applicable law.

Referring to the Figures, wherein like numerals indicate like or corresponding parts throughout the several views.

### Isolator

An aspect of the present invention is an embodiment, directed towards an isolator (101) in a suspension system (201), the isolator (101) comprising:
a. at least one microcellular polyurethane (MCU) (102);
b. a composite region (103) encapsulating the at least one MCU (102),
wherein the composite region (103) encapsulates the at least one MCU (102) partially or completely, and
c. optionally, at least one support region (105) attached to an at least one surface (104) of the composite region (103).

The isolator (101) includes at least one MCU (102) encapsulated by the composite region (103).

The at least one isolator (101) is a coil spring isolator for positioning between
a. a first arm (401) of a spring (400) and a spring seat region (311) of a vehicle body (301) of a vehicle, or
b. a second arm (402) and a spring seat region (312) of a movable component (302) of the vehicle, or
c. both.

The isolator (101) is shaped to be affixed in complementary shape of the spring seat region (311) or (312). Also, the isolator (101) is shaped to be affixed in complementary shape of the first arm (401) or the second arm (402) of the spring (400).

### Microcellular Urethane (MCU)

The at least one MCU (102) is softer/less stiff compared to the composite region (103). The MCU (102) being softer than the composite region (103) is configured to absorb noise, vibrations and jostles. The MCU (102) undergoes compression to absorb the impact force.

In an embodiment, the at least one MCU (102) of the isolator (101) is in a form selected from a disc with hole, a ring, a semiring, a polygon, a wire, a gauze, filings, an insert, a spring coil, and a sheet.

In another embodiment, the at least one MCU (102) of the isolator (101) has a suitable configuration selected from slit, polyhedron, parallelepiped, prism, prismoid, prismatoid, cone, cylinder, parallelograms, rhomboidal configuration, rectangular configuration, S-shaped configuration.

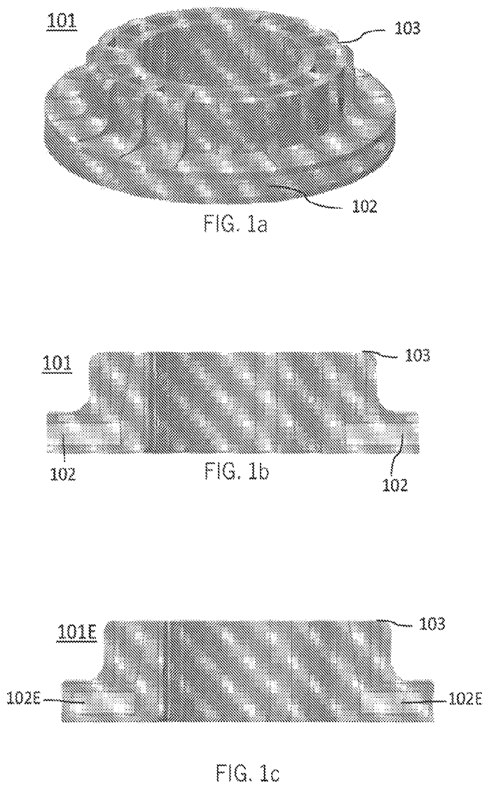

In an embodiment, the isolator (101) includes one MCU (102) in shape of a disc with a central hole as shown in FIG. 1a and FIG. 1b, such that the MCU (102) is coaxial with the composite region (103) of the isolator (101).

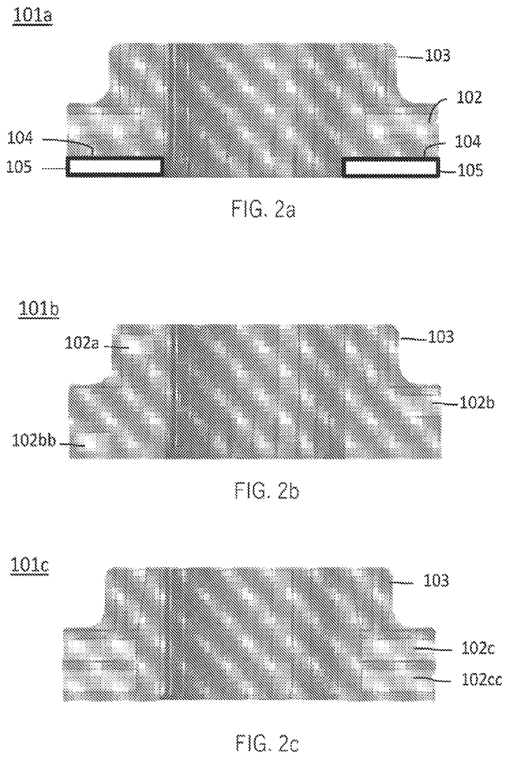

In another embodiment, the isolator (101a) includes one disc-shaped MCU (102) with a central hole, one disc-shaped support region (105) with a central hole as shown in FIG. 2a, such that the MCU (102) and the support region (105) are coaxial with the composite region (103) of the isolator (101).

In another embodiment the isolator (101) includes one disc-shaped MCU (102) with a central hole and one-disc shaped support region (105) with a central hole. In a preferred embodiment, the disc shaped support region (105) defines a hollow space. In another preferred embodiment, the disc shaped support region (105) is entirely solid.

In another embodiment, the isolator (101b) includes 3 MCU (102a, 102b, 102bb) shaped as inserts, such that the MCUs (102a, 102b, 102bb) are distributed across the composite region (103) as shown in FIG. 2b.

In another embodiment, the isolator (101c) includes at least two MCU (102c, 102cc) in shape of discs with a central hole stacked coaxially with each other as shown in FIG. 2c, such that the two MCU (102c and 102cc) are coaxial with the composite region (103) of the isolator (101).

In yet another embodiment, the isolator (101) includes the at least one MCU (102) partially encapsulated by the composite region (103) as shown in FIGS. 1a and 1b.

In yet another embodiment, the isolator (101E) includes the MCU (102E) in shape of a disc with central hole completely encapsulated by the composite region (103) as shown in FIG. 1c. The isolator (101E) with fully encapsulated MCU (102E) has capability to bear more load as the composite region (103) provides support from outer radial end and inner radial end of the MCU (102E).

In yet another embodiment, the at least one MCU (102) includes cellular elastomer, cellular polyisocyanate polyaddition products, or any combination thereof. In a preferred embodiment, the cellular elastomer includes microcellular polyurethane elastomer.

The microcellular polyurethane has a microcellular structure, i.e., the microcellular polyurethane presents cell walls defining cells, or void space. The cell walls have an original shape and the cells are generally filled with air. When the microcellular polyurethane is subjected to compressive forces, the cell walls are collapsed and air evacuates from the cells. When the compressive forces are removed, the cell walls return to the original shape. The use of microcellular urethane in compression application is beneficial because the microcellular polyurethane has a progressive load deflection curve, i.e., characteristic.

The microcellular polyurethane is formed from a two-step process. In the first step of the process, an isocyanate prepolymer is formed by reacting a polyol (P1) and an isocyanate (ISO1). The polyol (P1) is polyester (PEs1), and alternatively is polyether (PE1). The isocyanate (ISO1) is monomeric methyldiphenyl diisocyanate, and alternatively is naphthalene diisocyanate. However, it should be appreciated that the isocyanate (ISO1) can be of any type without departing from the nature of the present invention. In the second step of the process, the isocyanate prepolymer reacts with water to generate carbon dioxide and the carbon dioxide forms the cells of the microcellular polyurethane.

Polyester polyols (PEs1) are produced from the reaction of a dicarboxylic acid and a glycol having at least one primary hydroxyl group. For example, dicarboxylic acids that are suitable for producing the polyester polyols are selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. For example, glycols that are suitable for producing the polyester polyols are selected from the group of, but are not limited to, ethylene glycol, butylene glycol, hexanediol, bis(hydroxymethylcyclohexane), 1,4-butanediol, diethylene glycol, 2,2-dimethyl propylene glycol, 1,3-propylene glycol, and combinations thereof. The polyester polyol has a hydroxyl number of from 30 to 130, a nominal functionality of from 1.9 to 2.3, and a nominal molecular weight of from 1000 to 3000.

Polyether polyols (PE1) are produced from the cyclic ether propylene oxide, and alternatively ethylene oxide or tetrahydrofuran. Propylene oxide is added to an initiator in the presence of a catalyst to produce the polyester polyol. Polyether polyols (PE1) are selected from the group of, but are not limited to, polytetramethylene glycol, polyethylene glycol, polypropylene glycol, and combinations thereof. The polyether polyol (PE1) has a hydroxyl number of from 30 to 130, a nominal functionality of from 1.8 to 2.3, and a nominal molecular weight of from 1000 to 5000.

Diisocyanates are selected from the group of, but are not limited to, 4,4′-diphenylmethane diisocyanate, 2,4′-diphenylmethane diisocyanate, ethylene diisocyanate, ethylidene diisocyanate, propylene diisocyanate, butylene diisocyanate, cyclopentylene-1,3-diisocyanate, cyclohexylene-1,4-diisocyanate, cyclohexylene-1,2-diisocyanate, 2,4-toluylene diisocyanate, 2,6-toluylene diisocyanate, 2,2-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, tetramethylene diisocyanate, pentamethylene diisocyanate, hexamethylene diisocyanate, 1-chlorobenzene-2,4-diisocyanate, furfurylidene diisocyanate, and combinations thereof.

The monomeric methyldiphenyl diisocyanate is selected from the group of 4,4′-diphenylmethane diisocyanate, 2,4′-diphenylmethane diisocyanate, and combinations thereof.

The terms isocyanate, polyol, polyester polyol, polyether, and prepolymer referred herein above for formation of the MCU (102) also appear herein below for formation of the composite region (103) and the support region (105). Although the terms referred are attributed same meaning and function, the formulation/composition of the composite region (103) and the support region (105) differ from the formulation/composition of the MCU (102).

### Composite Region

In an embodiment, the isolator (101) includes the composite region (103) having stiffness greater than the stiffness of the at least one MCU (102). The composite region (103) is configured to have a high load bearing capacity. The composite region (103) being stiffer than the MCU (102), distributes the load along geometry of the isolator (101) over to less stiff/softer material i.e., the MCU (102). The MCU (102) absorbs the impact force and undergoes compression. Thus, the interaction of the composite region (103) and the encapsulated MCU (102) provides a high load bearing capacity to the isolator (101). Although the MCU (102) is less stiff, the interaction of the composite region (103) provides a good damping for the suspension system (200). The overall weight of the isolator (101) having the MCU (102) and the composite (103) is lesser than the rubber isolators that employ metal inserts.

In an embodiment, the composite region (103) is made of a mixture for injection molded material selected from a thermoplastic composite, a polyamide, a co-polyamide, an aromatic polyamides, a thermoplastic polyurethane (TPU), or any combination thereof.

In an embodiment, the composite region (103) encapsulates the at least one MCU (102) and provides the surface (104) for attachment of the optional support region (105). In a preferred embodiment, the isolator (101) includes the composite region (103) partially encapsulating the at least one MCU (102). In another preferred embodiment, the isolator (101) includes the composite region (103) completely encapsulating the at least one MCU (102).

In yet another preferred embodiment, the isolator (101) includes the composite region (101) partially encapsulating at least one MCU (102) and completely encapsulating at least one MCU (102).

In an embodiment, the composite region (103) defines a hollow space complementary to the shape of the spring seat region (311) or (312).

### Support Region

In an embodiment, the support region (105) is alternatively added to the isolator (101). The support region (105) is a resilient material configured to be optionally present on the surface (104) of the isolator (101). The support region (105) is configured to restrict deformity of the isolator (101) and provide structural stability. The support region (105) is obtainable in any shape and size complementary to the surface (104) of the isolator (101).

In yet another embodiment, the at least one support region (105) includes material selected from a metal, a steel, a hard plastic, a fibre, a nylon fibre with glass filler, wood, an additional layer of the composite region (103) or combination thereof.

In another embodiment, the at least one support region (105) includes fibre selected from metal fiber, metalized inorganic fiber, metalized synthetic fiber, glass fiber, polyester fiber, poly-amide fiber, polyvinyl alcohol fiber, aramid fiber, graphite fiber, carbon fiber, ceramic fiber, mineral fiber, basalt fiber, inorganic fiber, aramid fiber, kenaf fiber, jute fiber, flax fiber, hemp fiber, cellulosic fiber, sisal fiber and coir fiber.

In another embodiment, the at least one support region (105) is metal selected from a chemical element, an alloy, a molecular compound.

In yet another embodiment, the at least one support region (105) is made of the metal selected from iron, aluminium, titanium, magnesium, copper, stainless steel, alloy steel, polymeric sulfur-nitride, polythiazyl, bronze, and tin.

In a preferred embodiment, the at least one support region (105) is a stainless-steel ring. In a more preferred embodiment, the at least one support region (105) is made of steel S430 or S304.

In yet another embodiment, the at least one support region (105) is in a form selected from a hook, a socket, an insert, a bar, a semiring, a complementary coating layer, a protrusion, a disc with hole, a ring, a semiring, a polygon, a wire, a gauze, and a sheet.

In yet another embodiment, the support region (105) is a steel protrusion.

In yet another embodiment, the support region (105) is an additional layer of the composite region (103). In a preferred embodiment, the additional layer of the composite region (103) is made of same material as that of the composite region (103). In another preferred embodiment, the additional layer of the composite region (103) is made from a material different than the composite region (103).

In yet another embodiment, the support region (105) is a combination of a steel protrusion and an additional layer of the composite region (103).

In yet another embodiment, the support region (105) is subjected to a surface treatment agent. The surface treatment agent is also referred to as sizing. The support region (105) when subjected to the surface treatment agent further improve the mechanical properties of the injection molded material. Typically, sizing provides adhesion between the support region (105) and the surface (104) if the isolator (101).

### Method of Forming the Isolator

Another aspect of the present invention is an embodiment, directed towards a method of forming the isolator (101), wherein the method comprising:
a. providing at least one MCU (102) in a mold for the isolator (101);
b. optionally, providing the at least one support region (105) in the mold for the isolator (101)
c. injecting a mixture to form the composite region (103) into the mold and over the at least one MCU (102) and optionally the at least one support region (105);
d. optionally curing the mixture to form the isolator (101);
e. releasing the isolator (101) from the mold.

In an alternate embodiment the mixture is injected into the mold as well as over the at least one MCU (102). The at least one support region (105) is then snap fitted on the surface (104) of the isolator (101).

In an embodiment, the mold is in shape complementary to the shape of the isolator (101). The isolator (101) is formed such that the isolator (101) fits exactly on the spring seat region (311) or (312). Also, the isolator (101) is formed to be complementary in shape of the arm (401) or (402) of the spring (400).

In an embodiment, the at least one MCU (102) is provided in the mold of the isolator (101).

In an embodiment, the mixture to form the composite region (103) is injected into the mold and overmolds the at least one MCU (102) in the shape of the isolator (101). In an embodiment, after injecting the mixture over the at least one MCU (102), the mixture is optionally cured. The cured or uncured isolator (101) is released from the mold. In a preferred embodiment, the mixture is cured.

### Mixture to Form the Composite Region

In an embodiment, the mixture to form the composite region (103) includes a polyurethane, thermoplastic composite, polyamides, co-polyamides, and aromatic polyamides, a thermoplastic polyurethane, or any combination thereof.

In a preferred embodiment, the mixture to form the composite region (103) is a TPU.

In another embodiment, the mixture to form the composite region (103) is injection overmolding. Suitable overmolding techniques for the present invention are well known to the person skilled in the art. For instance, overmolding can be performed by arranging a heated injection barrel with a screw shaft arranged inside and linked to a hopper containing the TPU granules. The TPU is then fed into the injection barrel where it is heated and by the action of screw shaft, injected in a molten condition through a nozzle. In a further embodiment, the plastic material can be blended with the TPU and granules be injected in the molten condition through the nozzle. In one embodiment, the injection barrel has a temperature in between 210 °C to 230 °C, while the nozzle has a temperature in between 220 °C to 240 °C.

The terms isocyanate, polyol, polyester polyol, polyether, and prepolymer referred herein above for formation of the MCU (102) also appear herein below for formation of the mixture of the composite region (103). Although the terms referred are attributed same meaning and function, the formulation/composition of the composite region (103) differ from the formulation/composition of the MCU (102).

### Thermoplastic Polyurethane (TPU)

In an embodiment, the TPU has the shore hardness ranging from Shore D hardness of 54D to 80D, or from 60D to 80D, or from 70D to 80D.

In another embodiment, the TPU is obtained by reacting:
a. a polyol, (P2)
b. an isocyanate, (ISO2) and
c. optionally a chain extender (E2).

### Polyols (P2)

Suitable polyols (P2) have an average functionality in between 1.9 to 8.0, or in between 1.9 to 6.0, or in between 1.9 to 4.0 and a hydroxyl number in between 10 mg KOH/g to 1800 mg KOH/g, or in between 10 mg KOH/g to 1500 mg KOH/g, or even between 10 mg KOH/g to 1000 mg KOH/g. The polyols can be present in an amount in between 1 wt.-% to 99 wt.-%, based on the total weight of the TPU.

In one embodiment, the polyol (P2) is selected from polyether polyols (PE2), polyester polyols (PEs2), polyether-ester polyols (PE-Es2) and a mixture thereof.

Polyether polyols (PE2), according to the invention, have an average functionality in between 1.9 to 8.0, or in between 1.9 to 6.0, or in between 1.9 to 4.0, or in between 1.9 to 3.0, or even in be-tween 1.9 to 2.1 and a hydroxyl number in between 10 mg KOH/g to 1800 mg KOH/g, or in be-tween 10 mg KOH/g to 1500 mg KOH/g, or in between 10 mg KOH/g to 1000 mg KOH/g, or even between 10 mg KOH/g to 500 mg KOH/g.

Suitable polyether polyols (PE2) are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are generally selected such that their average functionality is in between 2.0 to 8.0, or in between 3.0 to 8.0. Optionally, a mixture of suitable starter molecules is used.

Starter molecules for polyether polyols (PE2) include amine containing and hydroxyl-containing starter molecules. Suitable amine containing starter molecules include, for example, aliphatic and aromatic diamines such as ethylenediamine, propylenediamine, butylenediamine, hexamethylene-diamine, phenylenediamines, toluenediamine, diaminodiphenylmethane and isomers thereof.

Other suitable starter molecules further include alkanolamines, e.g., ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

In one embodiment, amine containing starter molecules are selected from ethylenediamine, phenylenediamines, toluenediamine and isomers thereof. In other embodiment, the amine containing starter molecules comprise ethylenediamine.

Hydroxyl-containing starter molecules are selected from sugars, sugar alcohols, for e.g. glucose, mannitol, sucrose, pentaerythritol, sorbitol; polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

In one embodiment, the hydroxyl-containing starter molecules comprise sugar and sugar alco-hols such as sucrose, sorbitol, glycerol, pentaerythritol, trimethylolpropane and mixtures thereof. In other embodiment, the hydroxyl-containing starter molecules comprise sucrose, glycerol, pentaerythritol and trimethylolpropane.

Suitable alkylene oxides having 2 to 4 carbon atoms are, for example, ethylene oxide, propylene oxide, tetrahydrofuran, 1,2-butylene oxide, 2,3-butylene oxide and styrene oxide. Alkylene ox-ides can be used singly, alternatingly in succession or as mixtures. In one embodiment, the alkylene oxides are propylene oxide and/or ethylene oxide. In other embodiment, the alkylene ox-ides are mixtures of ethylene oxide and propylene oxide that comprise more than 50 wt.-% of propylene oxide.

In one embodiment, suitable polyether polyols (PE2) are derived from tetrahydrofuran. Tetrahydrofuran is a cyclic ether and is converted into a linear polymer called poly(tetramethylene ether)glycol (PTMEG) before obtaining the TPU. Commercially available polytetrahydrofuran, under the tradename PolyTHF® from BASF, can also be used.

Suitable amounts of the polyether polyols (PE2) are in between 1 wt.-% to 99 wt.-%, based on the total weight of the TPU.

Suitable polyester polyols (PEs2) have an average functionality in between 1.9 to 6.0, or between 1.9 to 5.0, or between 1.9 to 4.0, and a hydroxyl number in between 10 mg KOH/g to 500 mg KOH/g.

Polyester polyols (PEs2), according to the present invention, are based on the reaction product of carboxylic acids or anhydrides with hydroxyl group containing compounds. Suitable carboxylic ac-ids or anhydrides have from 2 to 20 carbon atoms, or from 4 to 18 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, oleic acid, phthalic anhydride. Particularly comprising phthalic acid, isophthalic acid, terephthalic acid, oleic acid and phthalic anhydride or a combination thereof.

Suitable hydroxyl containing compounds are selected from ethanol, ethylene glycol, propylene-1,2-glycol, propylene-1,3-glycol, butyl-ene-1,4-glycol, butylene-2,3-glycol, hexane-1,6-diol, oc-tane-1,8-diol, neopentyl glycol, cyclohexane dimethanol (1,4-bis-hydroxy-methylcyclohexane), 2-methyl-propane-1,3-diol, glycerol, trimethylolpropane, hex-ane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylene-propylene glycol, dibutylene glycol and polybutylene glycol. In one embodiment, the hydroxyl containing compounds are selected from ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside and diethylene glycol. In some embodiments, the hydroxyl containing compounds are selected from ethylene glycol, propylene-1,2-glycol, propylene-1,3-glycol, butyl-ene-1,4-glycol, butylene-2,3-glycol, hex-ane-1,6-diol, octane-1,8-diol, neopentyl glycol and diethylene glycol. In other embodiments, the hydroxyl containing compounds are selected from hexane-1,6-diol, neopentyl glycol, diethylene glycol.

Suitable polyether-ester polyols (PE-Es2) have a hydroxyl number in between 10 mg KOH/g to 500 mg KOH/g and an average functionality in between 1.9 to 5.0.

Such polyether-ester polyols (PE-Es2) are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

The starter molecules of component i) are generally selected such that the average functionality of component i) is in between 1.9 to 5.0. Optionally, a mixture of suitable starter molecules can be used.

In one embodiment, the hydroxyl-containing starter molecules of component i) are selected from sugars, sugar alcohols (glucose, mannitol, sucrose, pentaerythritol, sorbitol), polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, water and a mixture thereof.

In other embodiment, the hydroxyl-containing starter molecules of component i) are selected from sugars and sugar alcohols such as sucrose and sorbitol, glycerol, and mixtures of said sugars and/or sugar alcohols with glycerol, water and/or glycols such as, for example, diethylene glycol and/or dipropylene glycol.

Said fatty acid or fatty acid monoester ii) is selected from polyhydroxy fatty acids, ricinoleic acid, hydroxyl-modified oils, hydroxyl-modified fatty acids and fatty acid esters based in myristoleic acid, palmitoleic acid, oleic acid, stearic acid, palmitic acid, vaccenic acid, petroselic acid, gadoleic acid, erucic acid, nervonic acid, linoleic acid, a- and g-linolenic acid, stearidonic acid, arachidonic acid, timnodonic acid, clupanodonic acid, cervonic acid and a mixture thereof. Fatty acids can be used as purely fatty acids. In this regard, preference is given to using fatty acid methyl esters such as, for example, biodiesel or methyl oleate.

Biodiesel is to be understood as meaning fatty acid methyl esters within the meaning of the EN 14214 standard from 2010. Principal constituents of biodiesel, which is generally produced from rapeseed oil, soybean oil or palm oil, are methyl esters of saturated C16 to C18 fatty acids and methyl esters of mono- or polyunsaturated C18 fatty acids such as oleic acid, linoleic acid and linolenic acid.

Suitable alkylene oxides iii) having 2 to 4 carbon atoms are, for example, ethylene oxide, propylene oxide, tetrahydrofuran, 1,2-butylene oxide, 2,3-butylene oxide and/or styrene oxide. Alkylene oxides can be used singly, alternatingly in succession or as mixtures.

In one embodiment, the alkylene oxides comprise propylene oxide and ethylene oxide. In other embodiment, the alkylene oxide is a mixture of ethylene oxide and propylene oxide comprising more than 50 wt.-% of propylene oxide. In another embodiment, the alkylene oxide comprises purely propylene oxide.

### Chain Extender (CE2)

In an embodiment, the chain extender (CE2) has molecular weight in between 49 g/mol to 499 g/mol. In another embodiment, suitable chain extenders (CE2) are selected from alkanol amines, diols and/or triols having molecular weights in between 49 g/mol to 499 g/mol. Suitable amounts of these chain extenders (CE2) are known to the person skilled in the art. For instance, the chain extenders (CE2) can be present in an amount up to 99 wt.-%, or up to 20 wt.-%, based on the total weight of the TPU.

In one embodiment, suitable chain extenders (CE2) can be selected from ethylene glycol, diethylene glycol, triethylene glycol, propylene glycol, 1,3-propanediol, 1,4-butanediol, 1,5-pentanediol, 1,6-hexanediol, 1,4-butylene glycol, 1,5-pentylene glycol, methyl pentanediol, 1,6-hexylene glycol, neopentyl glycol, trimethylolpropane, glycerol, pentaerythritol, diglycerol, dextrose, 1,4:3,6 dianhydrohexitol, hydroquinone bis 2-hydroxyethyl ether and bis-2 (hydroxy ethyl)-terephthalate. In another embodiment, it can be selected from triethylene glycol, propylene glycol, 1,3-propanediol, 1,4-butanediol, 1,5-pentanediol, 1,6-hexanediol, 1,4-butylene glycol, 1,5-pentylene glycol, methyl pentanediol and 1,6-hexylene glycol. In still another embodiment, it can be select-ed from triethylene glycol, propylene glycol, 1,3-propanediol, 1,4-butanediol, 1,5-pentanediol, 1,6-hexanediol and 1,4-butylene glycol. In yet another embodiment, the chain extender comprises 1,4-butanediol.

### Isocyanate (ISO2)

Suitable isocyanates (ISO2) for the present invention comprise an aliphatic isocyanate or an aromatic isocyanate. It is to be understood that the isocyanate (ISO2) includes both monomeric and polymeric forms of the aliphatic and aromatic isocyanate. By the term “polymeric”, it is referred to the polymeric grade of the aliphatic and/or aromatic isocyanate comprising, independently of each other, different oligomers and homologues.

In an embodiment, the aliphatic isocyanate is selected from tetramethylene 1,4-diisocyanate, pentamethylene 1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, 1,3,5-cyclohexane triisocyanates, isocy-anatomethylcyclohexane isocyanates, isocyanatoethylcyclohexane isocyanates, bis(isocyanatomethyl)-cyclohexane diisocyanates, 4,4′-diisocyanatodicyclohexylmethane, pentamethylene 1,5-diisocyanate, isophorone diisocyanate and mixtures thereof.

In one embodiment, the aromatic isocyanate is used for obtaining the TPU in the embodiment 1. Suitable aromatic isocyanate is selected from toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl ben-zene-2,4,6-triisocyanate, tolidine diisocyanate and 1,3,5-triisopropyl benzene-2,4,6-triisocyanate.

In other embodiment, the aromatic isocyanates are selected from toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate. In yet other embodiment, the aromatic isocyanates com-prise toluene diisocyanate; polymeric toluene diisocyanate, methylene diphenyl diisocyanate and/or polymeric methylene diphenyl diisocyanate; m-phenylene diisocyanate; 1,5-naphthalene diisocyanate; 4-chloro-1; 3-phenylene diisocyanate. In still other embodiment, the aromatic iso-cyanates are selected from toluene diisocyanate; polymeric toluene diisocyanate, methylene diphenyl diisocyanate and/or polymeric methylene diphenyl diisocyanate; m-phenylene diisocyanate. In a further embodiment, the isocyanate comprises methylene diphenyl diisocyanate and/or polymeric methylene diphenyl diisocyanate.

Methylene diphenyl diisocyanate is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanate can be classified into monomeric methylene diphenyl diisocyanate and polymeric methylene di-phenyl diisocyanate referred to as technical methylene diphenyl diisocyanate. Polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2.0. The isomeric ratio as well as the amount of oligomeric species can vary in wide ranges in these products. For instance, polymeric methylene diphenyl diisocyanate may typically contain 30 wt.-% to 80 wt.-% of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene di-phenyl diisocyanate.

In another embodiment, reaction products of isocyanates (ISO2) with polyols (P2) and their mixtures with other diisocyanates and polyisocyanates can also be used.

In still another embodiment, the isocyanate (ISO2) comprises a polymeric methylene diphenyl diisocyanate, as described hereinabove.

Suitable amounts of isocyanates (ISO2) are such that the isocyanate index is in between 70 to 350, or in between 80 to 300. In one embodiment, the isocyanate index is in between 80 to 200, or 80 to 150, or 90 to 140. In another embodiment, it is in between 90 to 130, or 90 to 120, or 90 to 110. The isocyanate index describes the molar ratio of NCO groups to isocyanate reactive groups (polyol (P2) and chain extender (CE2)). An index of 100 relates to the ratio of 1:1.

### Other Reinforcing Agents

In one embodiment, the TPU further comprises other reinforcing agents. For the purpose of the pre-sent invention, reinforcing agent is selected from metal fiber, metalized inorganic fiber, metalized synthetic fiber, glass fiber, polyester fiber, polyamide fiber, polyvinyl alcohol fiber, aramid fiber, graphite fiber, carbon fiber, ceramic fiber, mineral fiber, basalt fiber, inorganic fiber, aramid fiber, kenaf fiber, jute fiber, flax fiber, hemp fiber, cellulosic fiber, sisal fiber and coir fiber.

In an embodiment, the reinforcing agent may be obtained in any shape and size. In another embodiment, the reinforcing agent is subjected to a surface treatment agent. The surface treatment agent is also referred to as sizing. The reinforcing agent when subjected to the surface treatment agent further improve the mechanical properties of the TPU. Typically, sizing provides adhesion between the reinforcing agent and the TPU.

In another embodiment, the surface treatment agent is a coupling agent and is selected from silane coupling agent, titanium coupling agent and aluminium coupling agent.

In one embodiment, the coupling agent comprises silane coupling agent. Suitable silane coupling agents are selected from aminosilane, epoxysilane, methyltrimethoxysilane, methyltriethoxysilane, Y-glycidoxypropyltrimethoxysilane, vinyltriacetoxysilane and vinyltrimethoxysilane.

Suitable amounts of the reinforcing agent in the TPU are well known to the person skilled in the art. In one embodiment, the amount of the reinforcing agent, as described herein, is such that the weight ratio between the reinforcing agent and the TPU is in between 0.01:1.0 to 1.0:1.0.

### Process for Making TPU

In still another embodiment, the TPU can be obtained in the presence of catalysts and/or additives. Suitable catalysts are well known to the person skilled in the art. Catalysts are selected from tertiary amine and phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof can be used as catalysts.

In one embodiment, catalyst is a tertiary amine. The tertiary amines include triethylamine, tributylamine, N-methylmorpholine, N-ethylmorpholine, N,N,N′,N′-tetramethylethylenediamine, pen-tamethyl-diethylenetriamine and higher homologues (as described in, for example, DE-A 2,624,527 and 2,624,528), 1,4-diazabicyclo(2.2.2) octane, N-methyl-N′-dimethyl-aminoethylpiperazine, bis-(dimethylaminoalkyl) piperazines, tris(dimethylaminopropyl) hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl)ether. Triazine compounds, such as, but not limited to, tris(dimethylaminopropyl) hexahydro-1,3,5-triazin can also be used.

In other embodiment, metal catalysts include, such as but not limited to, metal salts and organo-metallics comprising tin-, titanium-, zirconium-, hafnium, bismuth-, zinc-, aluminium- and iron compounds, such as tin organic compounds, preferably tin alkyls, such as dimethyltin or diethyl-tin, or tin organic compounds based on aliphatic carboxylic acids, preferably tin diacetate, tin dilaurate, dibutyl tin diacetate, dibutyl tin dilaurate, bismuth compounds, such as bismuth alkyls or related compounds, or iron compounds, preferably iron-(II)-acetylacetonate or metal salts of carboxylic acids, such as tin-II-isooctoate, tin dioctoate, titanium acid esters or bismuth-(III)-neodecanoate or a combination thereof.

The catalysts, as described hereinabove, can be present in amounts up to 20 wt.-%, based on the total weight of the TPU.

In another embodiment, additives are selected from alkylene carbonates, carbonamides, pyrrolidones, fillers, flame retardants, dyes, pigments, IR absorbing materials, UV stabilizers, plasticizers, antistats, fungistats, bacteriostats, hydrolysis controlling agents, antioxidants, cell regulators and mixtures thereof. Further details regarding additives can be found, for example, in the Szycher's Handbook of Polyurethanes, 2nd edition, 2013. Suitable amounts of these additives are well known to the person skilled in the art. However, for instance, the additives can be pre-sent in amounts up to 20 wt.-% based on the total weight of the TPU.

### Suspension System

Another aspect of the present invention is an embodiment, directed towards a suspension system (200) for a vehicle (300) having a vehicle body (301) and a movable component (302) displaceable relative to the vehicle body (301), the suspension system (200) comprising:
a. a spring (400) including a first arm (401) that articulates with a spring seat region (311) of the vehicle body (301) and a second arm (402) that articulates with a spring seat region (312) of the movable component (302); and
b. the at least one isolator (101) as claimed in any one of claims 1 to 12,
wherein the at least one isolator is disposed between
   the first arm (401) of a spring (400) and a spring seat region (311) of a vehicle body (301) of a vehicle, or
   the second arm (402) and a spring seat region (312) of a movable component (302) of the vehicle,
   or both.

The suspension system (200) comprises the spring (400), the at least one isolator (101) and optionally a shock/strut.

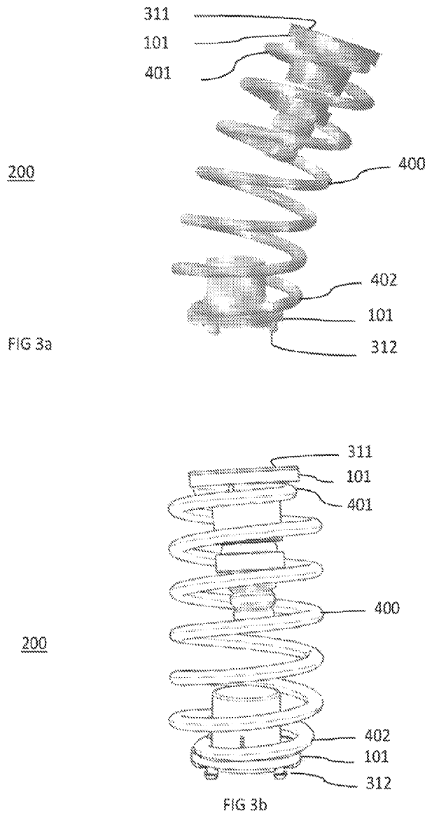

FIG. 3 provides views of the suspension system (200). FIGS. 3a and 3b provides variation in the spring (400) in the suspension system (200). FIG. 3a provides view of the suspension system (200) with the spring (400), the arms (401) and the isolators (101) are not in straight line of travel. FIG. 3b provide view of the suspension system (200) the spring (400) and the isolators (101) in straight line of travel.

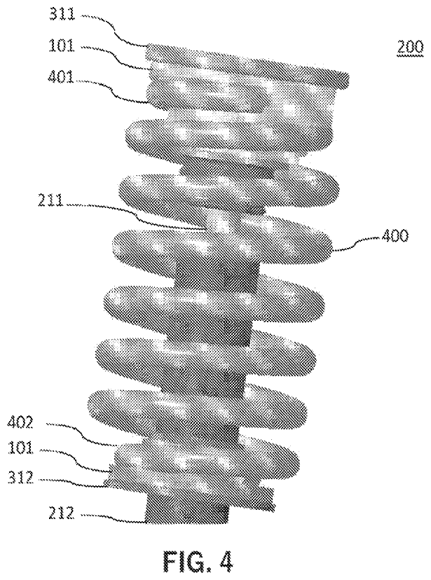

FIG. 4 provides view of the suspension system (200) in form of a MacPherson strut assembly. FIG. 4 provides view of the suspension system with a spring seat (401), the isolator (401), the spring (400), a strut piston rod (211), the isolators (101), the isolator (402), and a strut (212) as seen in a MacPherson strut type system.

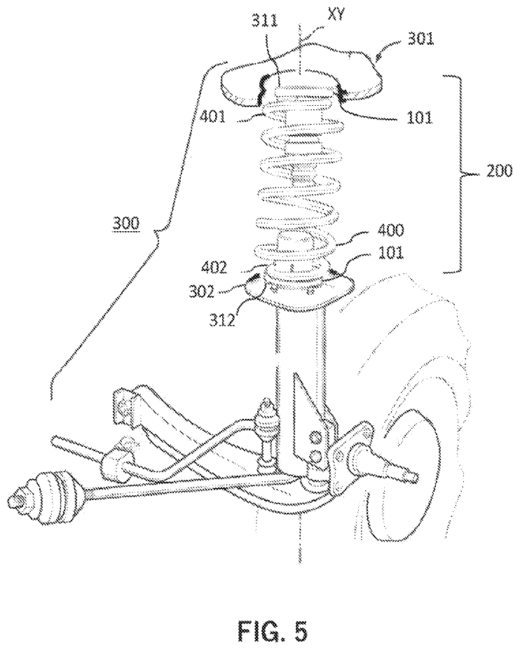

FIG. 5 provides views of the suspension system (200) in the vehicle (300).

### Spring

The spring (400) movement in response to impact force provides suspension action in a suspension system (200). The springs (400) include coil springs that is a bent wire in a helical shape. The coil springs include constant rate coil springs, progressive rate coil springs and dual rate coil springs.

In an embodiment, the spring (400) includes
a. the first arm (401) that articulates with the spring seat region (311) of the vehicle body (301) of the vehicle and
b. the second arm (402) that articulates with the spring seat region (312) of the movable component (302) of the vehicle.

### Vehicle

Another aspect of the present invention is an embodiment, directed towards a vehicle (300) comprising:
a. the vehicle body (301);
b. the movable component (302) displaceable relative to the vehicle body (301); and
c. the suspension system (200) with the at least one isolator (101).

The vehicle body (301) includes the passenger seating unit.

The movable component (302) includes the wheels.

The vehicle (300) is shown in the FIG. 5.

### Articulation of the Isolator in Suspension System

In an embodiment, the isolator (101) articulates between:
a. a first arm (401) of a spring (400) and a vehicle body (301) of a vehicle (300), or
b. a second arm (402) of the spring (400) and a movable component (302) of the vehicle, or
c. both.

First end of the at least one isolator (101) is disposed on the arm (401 or 402, or both) of the spring (400). The at least one isolator (101) is configured to interlock with the arms (401, 402) of the spring (400) to avoid slippage. The isolator (101) is tailored to accommodate the corresponding shape of arms (401, 402) of the spring (400). In a preferred embodiment, the spring (400) is a coil spring and the at least one isolator (101) is tailored to accommodate a pigtail end and barrel shape of the spring (400).

Second end of the at least one isolator (101) is disposed on a spring seat region (311) of the vehicle body (301) or the spring seat region (312) of the movable component (302) or both. The spring seat regions (311, 312) are cast into the vehicle body (301) or the movable component (302) or both. The spring seat region (311, 312) is alternatively welded into the vehicle body (301) or the movable component (302) or both.

The at least one isolator (101) is configured to assume a preselected position and shape based on shape of the spring seat region (311 or 312) of the vehicle body (301) or the movable component (302) or both.

### Vehicle and Suspension System Articulation

The vehicle (300) in motion generates vibration, rolling noise. When wheels associated with the movable component (302) of the vehicle (300) hits an obstruction during the motion, such as the curb, the impact force is generated. If the impact force is greater than that the spring (400) can absorb, the excess impact force is absorbed by the isolator (101).

Alternatively, when the suspension system (200) includes a MacPherson strut assembly as shown in FIG. 4, the impact force is absorbed by the strut (212) and the spring (400). The impact force greater than the capacity of the strut (212) and the spring (400) are then absorbed by the isolator (101).

As mentioned hereinabove, the vehicle is also subjected to noise, vibrations and jostles as the wheels rolls over the road and over the uneven surfaces. The arms (401) and (402) of the spring (400) transfer vibrations and jostles to the isolator (101).

The composite region (103) of the isolator (101) being stiffer compared to the at least one MCU (102) distributes the load along geometry of the isolator (101) to the at least one MCU (102). The at least one MCU (102) absorbs vibrations and jostles. The at least one MCU also absorbs the excess impact force transferred.

The impact force compresses the isolator (101). The greater the impact force, the greater the compression of the at least one MCU (102). The support region (105) restricts the excessive compression of the isolator and avoids structural deformity of the isolator (101).

It is to be appreciated that the isolator (101) provides additional load management capacity to absorb the surplus energy. Stiffness of the composite region (103) provides additional load bearing capacity to the isolator (101). The composite region (103) being overmolded on the at least one MCU (102) directs vibrations, jostles, and excess impact force if any to the at least one MCU (102). Further, the composite region (103) as well as the optional at least one support region (105) provides much needed structural stability to the isolator (101) and prevents deformation and deterioration. The at least one MCU (102) facilitates the absorption of vibrations, jostles and the excess impact force received. As the isolator (101) absorbs vibrations, jostles, and the surplus energy due to the impact force, the at least one MCU (102) undergoes compression.

The at least one isolator (101) interacting with the arms (401) and (402) of the spring as described herein, absorbs vibrations, jostles, and excess impact force. The isolator (101) minimises noise, vibration and harshness (NVH), prevents suspension overtravel, is light in weight and cost effective. In particular, the advantages are attributed to the composite region (103), the at least one MCU (102) and the optional support region (105) of the isolator (101) obtained by overmolding the at least one MCU (102) with the material for the composite region (103). Since the isolator (101) is prepared in shape complementary to the spring seat region (311) and (312), the isolator (101) is easily adaptable to variations of the suspension systems (200). Moreover, usage of the isolator (101) does not require any further structural changes to be done either for the spring (400) or for the suspension system (200) or for the vehicle (300).

### Advantages

In comparison with other coil spring isolators, the isolator (101) is associated with:
a. high load bearing capacity, thereby is capable to support extremely high load,
b. low stiffness and high damping,
c. lower weight than metal inserted rubber isolators,
d. no pierce through condition due to TPU's unique characteristics of high abrasion resistance, toughness, elasticity, and flexibility, and
e. reduced cost of the suspension system (200) by combining other shock components in one part.

The presently claimed invention is illustrated in more detail by the following embodiments and combinations of embodiments which results from the corresponding dependency references and links:

### Embodiments

I. An isolator (101) in a suspension system (201), the isolator (101) comprising:
   a. at least one microcellular polyurethane (MCU) (102);
   b. a composite region (103) encapsulating the at least one MCU (102),
   wherein the composite region (103) encapsulates the at least one MCU (102) partially or completely, and
   c. optionally, at least one support region (105) attached to an at least one surface (104) of the composite region (103).
II. The isolator (101) of embodiment I, wherein the at least one MCU (102) is in a form selected from a disc with hole, a ring, a semiring, a polygon, a wire, a gauze, filings, an insert, and a sheet.
III. The isolator (101) of any one of embodiments I or II, wherein the isolator (101) includes at least two MCU (102a, 102b, 102bb) distributed across the composite region (103) or at least two MCU (102c and 102cc) stacked coaxially with each other.
IV. The isolator (101) of any one of embodiments I to III, wherein the at least one MCU (102) is partially encapsulated by the composite region (103).
V. The isolator (101) of any one of embodiments I to III, wherein the at least one MCU (102E) is completely encapsulated by the composite region (103).
VI. The isolator (101) of any one of embodiments I to V, wherein the at least one MCU (102) includes cellular elastomer, cellular polyisocyanate polyaddition products, or any combination thereof.
VII. The isolator (101) of any one of embodiments I to VI, wherein the composite region (103) includes a thermoplastic composite, a polyamide, a co-polyamide, an aromatic polyamide, a thermoplastic polyurethane (TPU), or any combination thereof.
VIII. The isolator (101) of any one of embodiments I to VII, wherein the at least one support region (105) includes material selected from a metal, a steel, a hard plastic, a nylon fibre with glass filler, an additional layer of the composite region (103) or combination thereof.
IX. The isolator (101) of any one of embodiments I to VIII, wherein the at least one support region (105) is in a form selected from a hook, a socket, an insert, a bar, and a semiring, a complementary coating layer and a protrusion.
X. The isolator (101) of any one of embodiments I to IX, wherein the support region (105) is a steel protrusion.
XI. The isolator of any one of embodiments I to IX, wherein the support region (105) is an additional layer of the composite region (103).
XII. The isolator (101) of any one of embodiments I to IX, wherein the support region (105) is a combination of a steel protrusion and an additional layer of the composite region (103).
XIII. A method of forming the isolator (101) of any one of embodiments I to XII, wherein the method comprising:
   a. providing at least one MCU (102) in a mold for the isolator (101);
   b. optionally, providing the at least one support region (105) in the mold for the isolator (101)
   c. injecting a mixture to form the composite region (103) into the mold and over the at least one MCU and optionally the at least one support region (105);
   d. optionally curing the mixture to form the isolator (101);
   e. releasing the isolator (101) from the mold.
XIV. The method of embodiment XIII, wherein the mixture to form the composite region (103) includes a polyurethane, thermoplastic composite, polyamides, co-polyamides, and aromatic polyamides, a thermoplastic polyurethane, or any combination thereof.
XV. A suspension system (200) for a vehicle (300) having a vehicle body (301) and a movable component (302) displaceable relative to the vehicle body (301), the suspension system (200) comprising:
   a. a spring (400) including a first arm (401) that articulates with a spring seat region (311) of the vehicle body (301) and a second arm (402) that articulates with a spring seat region (312) of the movable component (302); and
   b. the at least one isolator (101) as claimed in any one of claims 1 to 12,
   wherein the at least one isolator is disposed between
      the first arm (401) of a spring (400) and a spring seat region (311) of a vehicle body (301) of a vehicle, or
      the second arm (402) and a spring seat region (312) of a movable component (302) of the vehicle,
      or both.
XVI. A vehicle (300) comprising:
   a. the vehicle body (301);
   b. the movable component (302) displaceable relative to the vehicle body (301); and
   c. the suspension system (200) with the at least one isolator (101) as described hereinabove.

The presently claimed invention is illustrated by the non-restrictive examples which are as follows:

### Raw Materials

TPU

| | |
|---|---|
| Hard TPU | Hard Thermoplastic Polyurethane |

Steel

| | |
|---|---|
| SS | Stainless steel S430 |
| SS a | Stainless steel S304 |

### Standard Methods:

| | |
|---|---|
| Energy | (J) Impact machine for dynamic testing Compression |
| | load/deflection test machine for static testing |

### Forming of the Isolator

The at least one MCU (102) is made of microcellular polyurethane and the support surface (105) was made of Stainless steel S430. The support surface (105) was prepared by stamping process. The support surface (105) had disc with a central aperture. The at least one MCU (102) and the support surface (105) was placed in a mold/an injection molding tool and shot with the mixture for the composite region (103) i.e., the mixture for TPU to make the isolator (101).

### LIST OF REFERENCE NUMERAL

| 101, 101E, 101a, 101b, 101c | Isolator |
|---|---|
| 102, 102E, 102a, 102b, 102c, 102cc | MCU |
| 103 | Composite region |
| 104 | Surface of Isolator |
| 105 | Support region |
| 200 | Suspension system |
| 211 | Piston rod |
| 212 | Strut |
| 300 | Vehicle |
| 301 | Vehicle body |
| 302 | Movable component |
| 311 | Spring seat region on Vehicle body |
| 312 | Spring seat region on Movable |
| | component |
| 400 | Spring |
| 401 | First arm of Spring |
| 402 | Second arm of Spring |

Obviously, many modifications and variations of the present invention are possible in light of the above teachings. The foregoing invention has been described in accordance with the relevant legal standards; thus, the description is exemplary rather than limiting in nature. Variations and modifications to the disclosed embodiment may become apparent to those skilled in the art and do come within the scope of the invention. Accordingly, the scope of legal protection afforded this invention may only be determined by studying the following claims.

1. An isolator (101) in a suspension system (201), the isolator (101) comprising:
a. at least one microcellular polyurethane (MCU) (102);
b. a composite region (103) encapsulating the at least one MCU (102),
wherein the composite region (103) encapsulates the at least one MCU (102) partially or completely, and
c. optionally, at least one support region (105) attached to an at least one surface (104) of the composite region (103).

2. The isolator (101) of claim 1, wherein the at least one MCU (102) is in a form selected from a disc with hole, a ring, a semiring, a polygon, a wire, a gauze, filings, an insert, a spring coil, and a sheet.

3. The isolator (101) of claim 1, wherein the isolator (101) includes at least two MCU (102a, 102b, 102bb) distributed across the composite region (103) or at least two MCU (102c and 102cc) stacked coaxially with each other.

4. The isolator (101) of claim 1, wherein the at least one MCU (102b) is partially encapsulated by the composite region (103).

5. The isolator (101) of claim 1, wherein the at least one MCU (102bb) is completely encapsulated by the composite region (103).

6. The isolator (101) of claim 1, wherein the at least one MCU (102) includes cellular elastomer, cellular polyisocyanate polyaddition products, or any combination thereof.

7. The isolator (101) of claim 1, wherein the composite region (103) includes a thermoplastic composite, a polyamide, a co-polyamide, an aromatic polyamide, a thermoplastic polyurethane (TPU), or any combination thereof.

8. The isolator (101) of claim 1, wherein the at least one support region (105) includes material selected from a metal, a steel, a hard plastic, a nylon fibre with glass filler, an additional layer of the composite region (103) or combination thereof.

9. The isolator (101) of claim 1, wherein the at least one support region (105) is in a form selected from a hook, a socket, an insert, a bar, and a semiring, a complementary coating layer and a protrusion.

10. The isolator (101) of claim 1, wherein the support region (105) is a steel protrusion.

11. The isolator (101) of claim 1, wherein the support region (105) is an additional layer of the composite region (103).

12. The isolator (101) of claim 1, wherein the support region (105) is a combination of a steel protrusion and an additional layer of the composite region (103).

13. A method of forming the isolator (101) of claim 1, wherein the method comprising:
a. providing at least one MCU (102) in a mold for the isolator (101);
b. optionally, providing the at least one support region (105) in the mold for the isolator (101)
c. injecting a mixture to form the composite region (103) into the mold and over the at least one MCU and optionally the at least one support region (105);
d. optionally curing the mixture to form the isolator (101);
e. releasing the isolator (101) from the mold.

14. The method of claim 13, wherein the mixture to form the composite region (103) includes a polyurethane, thermoplastic composite, polyamides, co-polyamides, and aromatic polyamides, a thermoplastic polyurethane, or any combination thereof.

15. A suspension system (200) for a vehicle (300) having a vehicle body (301) and a movable component (302) displaceable relative to the vehicle body (301), the suspension system (200) comprising:
a. a spring (400) including a first arm (401) that articulates with a spring seat region (311) of the vehicle body (301) and a second arm (402) that articulates with a spring seat region (312) of the movable component (302); and
b. the at least one isolator (101) as claimed in claim 1, wherein the at least one isolator is disposed between
the first arm (401) of a spring (400) and a spring seat region (311) of a vehicle body (301) of a vehicle, or
the second arm (402) and a spring seat region (312) of a movable component (302) of the vehicle,
or both.

16. A vehicle (300) comprising:
a. the vehicle body (301);
b. the movable component (302) displaceable relative to the vehicle body (301); and
c. the suspension system (200) with the at least one isolator (101) as claimed in claim 1.
